(19) United States
(12) Patent Application Publication
(10) Pub. No.: US 2026/0169276 A1
(43) Pub. Date: Jun. 18, 2026

(54) MICROSCOPE OBJECTIVE LENS TURRET AND MICROSCOPE

(71) Applicant: AAC Microtech (Changzhou) Co., Ltd., Changzhou City (CN)

(72) Inventors: Chongdeng Wu, Changzhou (CN); Rui Zhang, Changzhou (CN); Zhou Yu, Changzhou (CN); Huifang Dong, Changzhou (CN); Jialin Wang, Changzhou (CN)

(21) Appl. No.: 19/064,647

(22) Filed: Feb. 26, 2025

Related U.S. Application Data
(63) Continuation of application No. PCT/CN2024/138650, filed on Dec. 12, 2024.

(51) Int. Cl. G02B 21/24; G02B 7/16; G02B 21/02

(52) U.S. Cl. CPC G02B 21/248; G02B 7/16; G02B 21/02

(57) ABSTRACT

A microscope objective lens turret and a microscope are provided. The microscope objective lens turret includes a pedestal, a rotary sleeve rotatably connected to the pedestal, a turntable fixed to the rotary sleeve, and a support member connected to the pedestal and the turntable. The support member includes a first inner ring fixed to the pedestal, a first outer ring fixed to the turntable and defining a first raceway with the first inner ring, and a plurality of first balls received in the first raceway. The support member of the disclosure is a four-point contact bearing, has higher precision and rigidity, can make the precision of the microscope objective lens turret higher, and improve the finished product performance of the microscope objective lens turret.

### CROSS REFERENCE TO RELATED APPLICATIONS

The present application is a continuation of PCT Patent Application No. PCT/CN 2024/138650, filed Dec. 12, 2024, which is incorporated by reference herein in its entirety.

### TECHNICAL FIELD

The various embodiments described in this document relate in general to the technical field of microscopes, and more specifically to a microscope objective lens turret and a microscope.

### BACKGROUND

In the related technologies, an objective lens switching device of a microscope can drive the objective lenses to rotate through a rotatable turntable to realize switching of different objective lenses. An inner ring and an outer ring of the turntable are supported by bearings, where the central hole of the turntable is processed into a stepped shape, and a surface of a motor support, which is fixed to the base, for mounting balls forms a conical surface. The appropriate number of balls are placed between a disk surface of the turntable and the motor support. The balls, the conical surface of the motor support, and the stepped central hole of the turntable form a three-point contact bearing. That is, the inner ring of the turntable is supported by the three-point contact bearing. However, the accuracy and rigidity of the three-point contact bearing are poor, resulting in poor finished performance of the microscope objective lens turret.

Therefore, it is necessary to provide a new microscopic objective lens turntable.

### SUMMARY

The disclosure aims to provide a microscopic objective lens turret and a microscope, which can solve the technical problem of poor accuracy and rigidity due to the use of three-point contact bearing support for the inner ring of the turntable in the related technologies.

The technical solutions of the disclosure are as follows.

A microscope objective lens turret is provided and includes a pedestal, a rotary sleeve rotatably connected to the pedestal, a turntable fixed to the rotary sleeve, and a support member connected to the pedestal and the turntable. The support member includes a first inner ring fixed to the pedestal, a first outer ring fixed to the turntable and defining a first raceway with the first inner ring, and a plurality of first balls received in the first raceway. The support member further includes an annular holder received in the first raceway, and the annular holder defines a plurality of positioning holes arranged at intervals along a circumferential direction of the first raceway, where the plurality of first balls are fitted in the plurality of positioning holes in one-to-one correspondence.

In some embodiments, the annular holder defines a plurality of insertion grooves on a side of the annular holder, where each respective insertion groove of the plurality of insertion grooves is communicatively coupled to a respective positioning hole of the plurality of positioning holes, where the respective insertion groove has a first side wall and a second side wall spaced apart from each other in a circumferential direction of the annular holder, and a distance between the first side wall and the second side wall is larger than a diameter of the respective positioning hole.

In some embodiments, the distance between the first side wall and the second side wall gradually decreases in a direction from the first inner ring toward the first outer ring.

In some embodiments, a first gap is defined between the annular holder and a side of the first inner ring close to the first outer ring, and a second gap is defined between the annular holder and a side of the first outer ring close to the first inner ring.

In some embodiments, the first inner ring defines a first annular slot on a side of the first inner ring close to the first outer ring, and the first outer ring defines a second annular slot on a side of the first outer ring close to the first inner ring, where the first annular slot and the second annular slot are both adapted to the plurality of first balls, and the first annular slot and the second annular slot jointly form the first raceway.

In some embodiments, the turntable defines a mounting hole, and at least part of the pedestal and the support member are accommodated in the mounting hole, where the first inner ring is sleeved and fixed on an outer side of the pedestal, and the first outer ring is embedded in the mounting hole.

In some embodiments, a first limit portion is provided on an inner peripheral wall of the mounting hole, and a second limit portion is provided on an outer side of the pedestal, where the first limit portion and the second limit portion are separated in an axial direction of the support member, the first outer ring abuts on the first limit portion, and the first inner ring abuts on the second limit portion.

In some embodiments, the support member further includes a base fixed to the pedestal and defining a second raceway with the turntable, and a plurality of second balls accommodated in the second raceway, where a diameter of the first raceway is smaller than that of the second raceway.

In some embodiments, the second raceway has a bottom wall corresponding to the base, and a third side wall and a fourth side wall that are connected to the bottom wall and are disposed opposite to each other, where the third side wall is closer to the support member than the fourth side wall, and the third side wall is inclined toward the support member.

A microscope including a microscope objective lens turret as described in any one of the above.

The disclosure has the following beneficial effects. The annular holder is disposed between the first outer ring and the first inner ring, and the plurality of first balls in the first raceway are assembled in the plurality of positioning holes on the annular holder in one-to-one correspondence, so that the support member is a four-point contact bearing. Compared with the three-point contact bearing in the related technologies, the four-point contact bearing has a higher accuracy and rigidity, so that the accuracy of the microscope objective lens turret may be higher and the finished product performance of the microscope objective lens turret may be improved. Moreover, the material and processing requirements of the pedestal and the turntable can be reduced, which is beneficial to reducing the cost.

### BRIEF DESCRIPTION OF THE DRAWINGS

FIG. 1 is a schematic structural diagram of a microscope objective lens turret according to embodiments of the disclosure.

FIG. 2 is a cross-sectional view taken along a A-A direction of FIG. 1.

FIG. 3 is an enlarged view of part B of FIG. 2.

FIG. 4 is an enlarged view of part C in FIG. 2.

FIG. 5 is an assembly schematic diagram between a turntable, a support member, and second balls according to embodiments of the disclosure.

FIG. 6 is a schematic structural diagram of a support member according to embodiments of the disclosure.

FIG. 7 is an explosion view of a support member according to embodiments of the disclosure.

### DETAILED DESCRIPTION OF THE EMBODIMENTS

The disclosure will be further described below with reference to the accompanying drawings and embodiments.

The disclosure provides a microscope, and the microscope includes a microscope objective lens turret, and an eyepiece and a plurality of objective lenses arranged on the microscope objective lens turret. The plurality of objective lenses are arranged at intervals along a circumferential direction of the microscope objective lens turret. The plurality of objective lenses have different magnification factors. When the microscope objective lens turret is operated, the objective lenses can be driven to rotate in the circumferential direction, so that the eyepiece can match the objective lenses with different magnification factors.

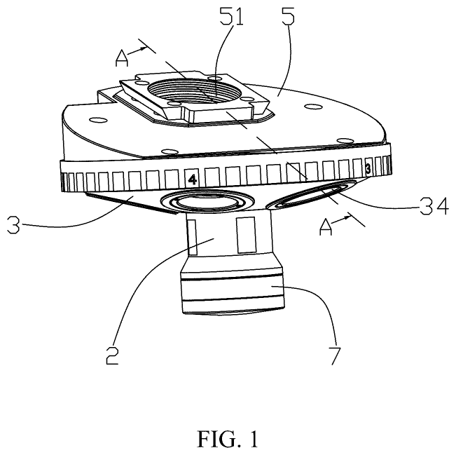

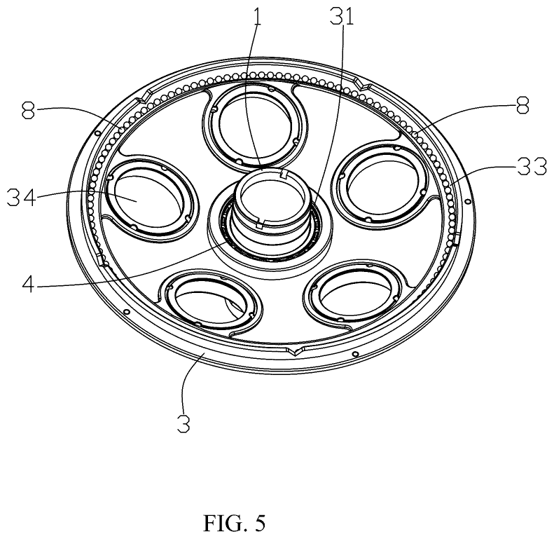

Referring to FIGS. 1 to 7, the microscope objective lens turret includes a pedestal 1, a rotary sleeve 2 rotatably connected to the pedestal 1, a turntable 3 fixed to the rotary sleeve 2, and a support member 4 connected to the pedestal 1 and the turntable 3. The support member 4 includes a first inner ring 41 fixed to the pedestal 1, a first outer ring 42 fixed to the turntable 3 and defining a first raceway 45 with the first inner ring 41, and a plurality of first balls 43 received in the first raceway 45. The support member 4 further includes an annular holder 44 received in the first raceway 45, and the annular holder 44 defines a plurality of positioning holes 441 arranged at intervals along a circumferential direction of the first raceway 45. The plurality of first balls 43 are fitted in the plurality of positioning holes 441 in one-to-one correspondence.

By providing the annular holder 44 between the first outer ring 42 and the first inner ring 41 and assembling the plurality of first balls 43 in the first raceway 45 into the plurality of positioning holes 441 on the annular holder 44 in one-to-one correspondence, the support member 4 is provided as a four-point contact bearing. Compared with the three-point contact bearing in the related technologies, the four-point contact bearing has a higher accuracy and rigidity, so that the accuracy of the microscope objective lens turret may be higher and the finished product performance of the microscope objective lens turret may be improved. Moreover, the material and processing requirements of the pedestal 1 and the turntable 3 can be reduced, which is beneficial to reducing the cost.

It is to be noted that the plurality of positioning holes 441 on the annular holder 44 are preferably arranged at equal intervals. Each first ball may be a steel ball, and the number of the plurality of first balls 43 and the number of the plurality of positioning holes 441 are the same. The number of the plurality of first balls 43 is set according to actual needs, for example, the number of the plurality of first balls 43 may be five, ten, twelve, twenty, thirty, or the like.

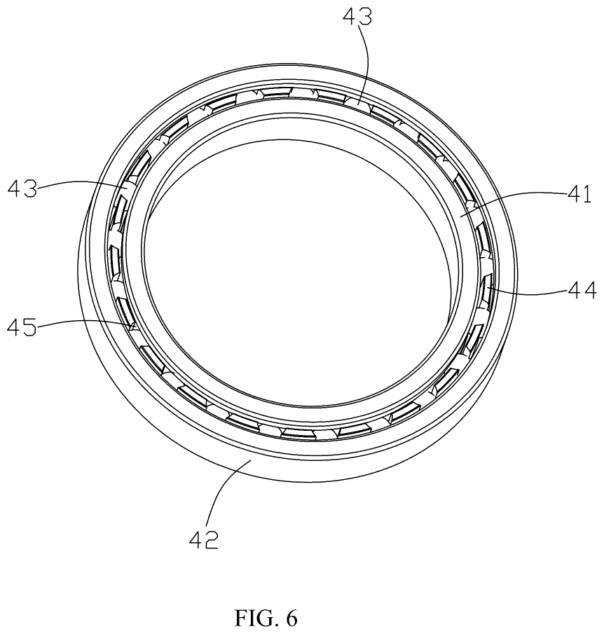

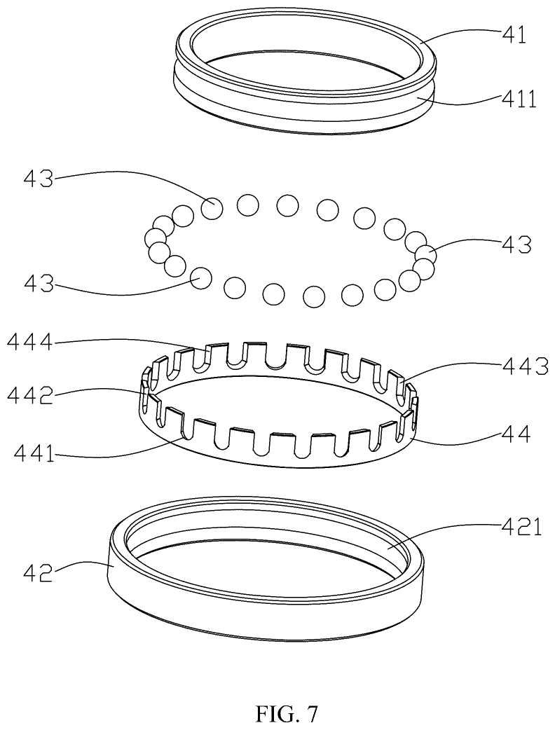

Referring to FIGS. 6 and 7, the annular holder 44 defines a plurality of insertion grooves 442 on one side of the annular holder 44, where each of the plurality of insertion grooves 442 is communicatively coupled to a respective positioning hole 441. The insertion groove 442 has a first side wall 443 and a second side wall 444 spaced apart from each other in the circumferential direction of the annular holder 44. A distance between the first side wall 443 and the second side wall 444 is larger than a diameter of the positioning hole 441, so that a width of the insertion groove 442 is larger than the diameter of the positioning hole 441. In addition, since the diameter of the positioning hole 441 is adapted to that of the first ball 43, it is convenient for the first ball 43 to pass through the insertion groove 442 and be assembled into the positioning hole 441. Furthermore, the insertion groove 442 can also guide the assembly of the first ball 43 into the positioning hole 441.

It is to be noted that in the assembly process of the support member 4, the plurality of first balls 43 may be assembled in the first raceway 45 first, and then the annular holder 44 may be inserted into the first raceway 45, such that each of the plurality of first balls 43 may be inserted into the respective positioning hole 441 along a respective one of the plurality of insertion grooves 442, thereby completing the assembly of the support member 4. In this way, the assembly method is simple and convenient.

Referring to FIGS. 6 and 7, in a direction from the first inner ring 41 toward the first outer ring 42, the distance between the first side wall 443 and the second side wall 444 gradually decreases, which is beneficial to prevent the first balls 43 from separating from the annular holder 44. In addition, it is also possible to ensure the smoothness of the first balls 43 rolling in the first raceway 45.

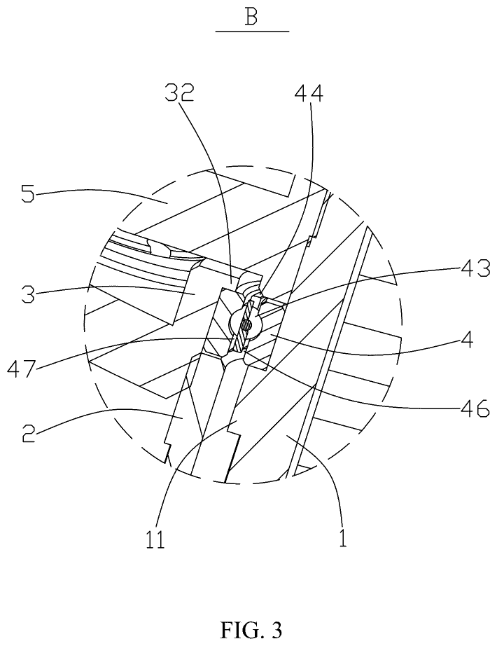

Referring to FIGS. 3, 5, and 6, there is a first gap 46 between the annular holder 44 and a side of the first inner ring 41 close to the first outer ring 42, and a second gap 47 between the annular holder 44 and a side of the first outer ring 42 close to the first inner ring 41, so that the annular holder 44 does not come into contact with the first inner ring 41 and the first outer ring 42, and the annular holder 44 is prevented from obstructing the relative movement between the first inner ring 41 and the first outer ring 42. Furthermore, it is also conducive to driving the annular holder 44 by the first balls 43 to move in the first raceway 45.

Referring to FIGS. 6 and 7, the first inner ring 41 defines a first annular slot 411 on the side of the first inner ring 41 close to the first outer ring 42, and the first outer ring 42 defines a second annular slot 421 on the side of the first outer ring 42 close to the first inner ring 41. The first annular slot 411 and the second annular slot 421 are both adapted to the plurality of first balls 43, and the first annular slot 411 and the second annular slot 421 jointly form the first raceway 45. The first annular slot 411 and the second annular slot 421 are both arc-shaped slots. When the plurality of first balls 43 are received in the first raceway 45, the first balls 43 are limited in the first raceway 45 by the cooperation of the first annular slot 411 and the second annular slot 421.

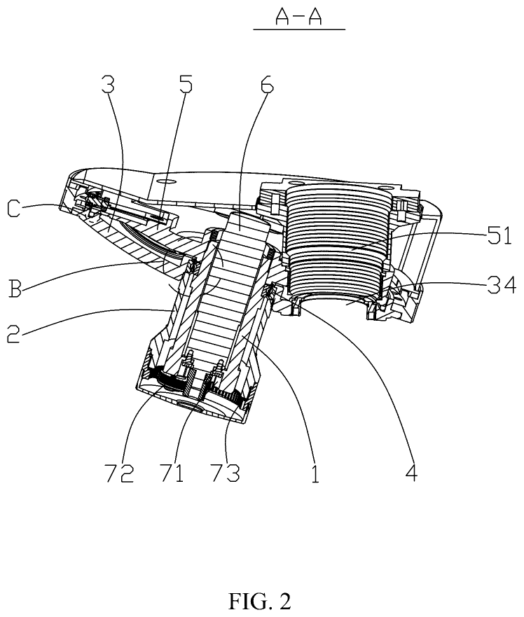

Referring to FIGS. 2, 3, and 5, the turntable 3 defines a mounting hole 31, and at least part of the pedestal 1 and the support member 4 are accommodated in the mounting hole 31. The first inner ring 41 is sleeved and fixed on an outer side of the pedestal 1. The first outer ring 42 is embedded in the mounting hole 31, so that the support member 4 can support the turntable 3 while ensuring that the turntable 3 can rotate relative to the pedestal 1. According to actual needs, a middle part of the pedestal 1 is accommodated in the mounting hole 31, and both ends of the pedestal 1 are located outside the mounting hole 31.

Referring to FIGS. 2 and 3, a first limit portion 32 is provided on an inner peripheral wall of the mounting hole 31, and a second limit portion 11 is provided on an outer side of the pedestal 1. The first limit portion 32 and the second limit portion 11 are separated in an axial direction of the support member 4. The first outer ring 42 abuts on the first limit portion 32, and the first inner ring 41 abuts on the second limit portion 11. By providing the first limit portion 32 and the second limit portion 11, the support member 4 can be prevented from moving in the axial direction, and the stability of rotation of the turntable 3 can be improved.

Referring to FIGS. 1 and 2, the microscope objective lens turret further includes a driving source 6 fixed to the pedestal 1, and a transmission mechanism 7 provided on the pedestal 1 and connected to the driving source 6 and the rotary sleeve 2. The transmission mechanism 7 includes a baseplate 71 fixed to an end of the pedestal 1 away from the first inner ring 41, at least one first gear 72 rotatably connected to the baseplate 71 and connected to the driving source 6, and a second gear 73 fixed to the rotary sleeve 2 and meshed with the at least one first gear 72. The rotary sleeve 2 is sleeved on the outer side of the pedestal 1. The rotary sleeve 2 is located on a side of the first outer ring 42 away from the first limit portion 32. The second gear 73 is disposed at an end of the rotary sleeve 2 away from the first outer ring 42. The driving source 6 may be a direct-current (DC) motor with output teeth. The driving source 6 is configured to drive the at least one first gear 72 to rotate. Each of the at least one first gear 72 may be planetary teeth. The at least one first gear 72 is embodied as two first gears 72. One of the two first gears 72 is provided on a side of two opposite sides of the output teeth of the DC motor and the other of the two first gears 72 is provided on the other side of the two opposite sides of the output teeth. The arrangement of the two first gears 72 is beneficial to stably transmit the power of the driving source 6 to the second gear 73. The second gear 73 rotates in cooperation with the first gear 72 and drives the rotary sleeve 2 to rotate. The second gear 73 can provide deceleration and transmit power to the rotary sleeve 2, and the rotary sleeve 2 drives the turntable 3 to rotate, so that the rotary sleeve 2 can transmit power of the driving source 6 to the turntable 3.

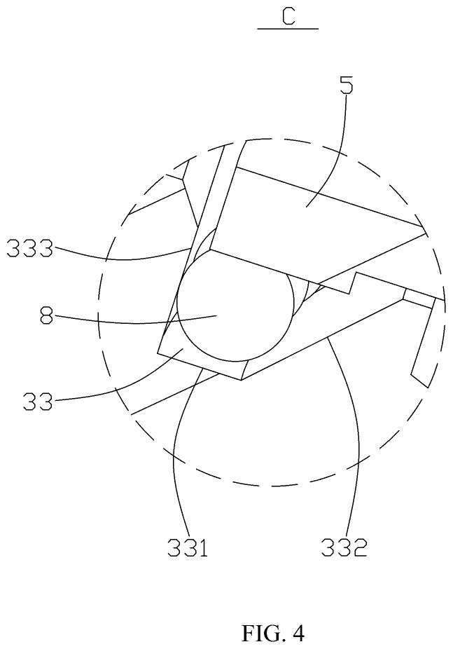

Referring to FIGS. 2 and 4, the support member 4 further includes a base 5 fixed to the pedestal 1 and defining a second raceway 33 with the turntable 3, and a plurality of second balls 8 accommodated in the second raceway 33. A diameter of the first raceway 45 is smaller than that of the second raceway 33. That is, the first raceway 45 is located in the second raceway 33, and a two-point contact bearing is formed between the base 5, the plurality of second balls 8, and the turntable 3, so that the turntable 3 is rotatable relative to the base 5 while supporting the base 5. The number of the plurality of second balls 8 is set according to actual needs, for example, six, ten, fifteen, twenty, or the like.

Referring to FIGS. 2 and 4, the second raceway 33 has a bottom wall 331 corresponding to the base 5, and a third side wall 332 and a fourth side wall 333 that are connected to the bottom wall 331 and are disposed opposite to each other. The third side wall 332 is closer to the support member 4 than the fourth side wall 333. The third side wall 332 is inclined toward the support member 4, which facilitates the rolling of the plurality of second balls 8 within the second raceway 33.

It shall be noted that the base 5 may provide integral support to the microscope objective lens turret. Since the support member 4 is connected to the pedestal 1 and the turntable 3, the support 4 can support the rotation of the turntable 3. The plurality of second balls 8 are disposed in the second raceway 33, and the plurality of second balls 8 are in contact with the turntable 3 and the base 5, so that the plurality of second balls 8 can provide vertical support to the turntable 3.

Referring to FIGS. 1 and 2, the turntable 3 defines a plurality of objective lens threaded holes 34, and the plurality of objective lenses are assembled in the plurality of objective lens threaded holes 34 in one-to-one correspondence. The base 5 defines an eyepiece threaded hole 51, and the eyepiece is fitted in the eyepiece threaded hole 51. When the driving source 6 drives the rotary sleeve 2 to rotate and the turntable 3 is driven by the rotary sleeve 2 to rotate, one of the plurality of objective lenses can be rotated to be directly facing the eyepiece, so that the eyepiece can be paired with the objective lenses of different magnification factors, thus allowing for the adjustment of the microscope's magnification factor.

The elements defined by the terms “inner” and “outer” refer to the elements are in relative positions as the microscope objective lens turret is assembled, where the element defined by the term “inner” is closer to the longitudinally central axis of the microscope objective lens turret than that of the element defined by the term “outer”.

The above description is merely some embodiments of the present disclosure, and it is to be pointed out here that those skilled in the art can make improvements without departing from the inventive concept of the present disclosure, but these are all within the scope of protection of the present disclosure.

What is claimed is:

1. A microscope objective lens turret, comprising a pedestal, a rotary sleeve rotatably connected to the pedestal, a turntable fixed to the rotary sleeve, and a support member connected to the pedestal and the turntable, wherein
the support member includes a first inner ring fixed to the pedestal, a first outer ring fixed to the turntable and defining a first raceway with the first inner ring, and a plurality of first balls received in the first raceway; and
the support member further includes an annular holder received in the first raceway, and the annular holder defines a plurality of positioning holes arranged at intervals along a circumferential direction of the first raceway, wherein the plurality of first balls are fitted in the plurality of positioning holes in one-to-one correspondence.

2. The microscopic objective lens turret of claim 1, wherein the annular holder defines a plurality of insertion grooves on a side of the annular holder, wherein each respective insertion groove of the plurality of insertion grooves is communicatively coupled to a respective positioning hole of the plurality of positioning holes, wherein the respective insertion groove has a first side wall and a second side wall spaced apart from each other in a circumferential direction of the annular holder, and a distance between the first side wall and the second side wall is larger than a diameter of the respective positioning hole.

3. The microscopic objective lens turret of claim 2, wherein the distance between the first side wall and the second side wall gradually decreases in a direction from the first inner ring toward the first outer ring.

4. The microscope objective lens turret of claim 1, wherein a first gap is defined between the annular holder and a side of the first inner ring close to the first outer ring, and a second gap is defined between the annular holder and a side of the first outer ring close to the first inner ring.

5. The microscope objective lens turret of claim 1, wherein the first inner ring defines a first annular slot on a side of the first inner ring close to the first outer ring, and the first outer ring defines a second annular slot on a side of the first outer ring close to the first inner ring, wherein the first annular slot and the second annular slot are both adapted to the plurality of first balls, and the first annular slot and the second annular slot jointly form the first raceway.

6. The microscope objective lens turret of claim 1, wherein the turntable defines a mounting hole, and at least part of the pedestal and the support member are accommodated in the mounting hole, wherein the first inner ring is sleeved and fixed on an outer side of the pedestal, and the first outer ring is embedded in the mounting hole.

7. The microscope objective lens turret of claim 6, wherein a first limit portion is provided on an inner peripheral wall of the mounting hole, and a second limit portion is provided on an outer side of the pedestal, wherein the first limit portion and the second limit portion are separated in an axial direction of the support member, the first outer ring abuts on the first limit portion, and the first inner ring abuts on the second limit portion.

8. The microscope objective lens turret of claim 1, wherein the support member further includes a base fixed to the pedestal and defining a second raceway with the turntable, and a plurality of second balls accommodated in the second raceway, wherein a diameter of the first raceway is smaller than that of the second raceway.

9. The microscope objective lens turret of claim 8, wherein the second raceway has a bottom wall corresponding to the base, and a third side wall and a fourth side wall that are connected to the bottom wall and are disposed opposite to each other, wherein the third side wall is closer to the support member than the fourth side wall, and the third side wall is inclined toward the support member.

10. A microscope, comprising a microscopic objective lens turret comprising:
a pedestal, a rotary sleeve rotatably connected to the pedestal, a turntable fixed to the rotary sleeve, and a support member connected to the pedestal and the turntable, wherein
the support member includes a first inner ring fixed to the pedestal, a first outer ring fixed to the turntable and defining a first raceway with the first inner ring, and a plurality of first balls received in the first raceway; and
the support member further includes an annular holder received in the first raceway, and the annular holder defines a plurality of positioning holes arranged at intervals along a circumferential direction of the first raceway, wherein the plurality of first balls are fitted in the plurality of positioning holes in one-to-one correspondence.

11. The microscope of claim 10, wherein the annular holder defines a plurality of insertion grooves on a side of the annular holder, wherein each respective insertion groove of the plurality of insertion grooves is communicatively coupled to a respective positioning hole of the plurality of positioning holes, wherein the respective insertion groove has a first side wall and a second side wall spaced apart from each other in a circumferential direction of the annular holder, and a distance between the first side wall and the second side wall is larger than a diameter of the respective positioning hole.

12. The microscope of claim 11, wherein the distance between the first side wall and the second side wall gradually decreases in a direction from the first inner ring toward the first outer ring.

13. The microscope of claim 10, wherein a first gap is defined between the annular holder and a side of the first inner ring close to the first outer ring, and a second gap is defined between the annular holder and a side of the first outer ring close to the first inner ring.

14. The microscope of claim 10, wherein the first inner ring defines a first annular slot on a side of the first inner ring close to the first outer ring, and the first outer ring defines a second annular slot on a side of the first outer ring close to the first inner ring, wherein the first annular slot and the second annular slot are both adapted to the plurality of first balls, and the first annular slot and the second annular slot jointly form the first raceway.

15. The microscope of claim 10, wherein the turntable defines a mounting hole, and at least part of the pedestal and the support member are accommodated in the mounting hole, wherein the first inner ring is sleeved and fixed on an outer side of the pedestal, and the first outer ring is embedded in the mounting hole.

16. The microscope of claim 15, wherein a first limit portion is provided on an inner peripheral wall of the mounting hole, and a second limit portion is provided on an outer side of the pedestal, wherein the first limit portion and the second limit portion are separated in an axial direction of the support member, the first outer ring abuts on the first limit portion, and the first inner ring abuts on the second limit portion.

17. The microscope of claim 10, wherein the support member further includes a base fixed to the pedestal and defining a second raceway with the turntable, and a plurality of second balls accommodated in the second raceway, wherein a diameter of the first raceway is smaller than that of the second raceway.

18. The microscope of claim 17, wherein the second raceway has a bottom wall corresponding to the base, and a third side wall and a fourth side wall that are connected to the bottom wall and are disposed opposite to each other, wherein the third side wall is closer to the support member than the fourth side wall, and the third side wall is inclined toward the support member.
